(19) United States
(12) Patent Application Publication
(10) Pub. No.: US 2011/0112879 A1
(43) Pub. Date: May 12, 2011

(54) METHOD AND APPARATUS TO MANAGE A WORKFORCE

(76) Inventor: Jason Fama, Redwood City, CA (US)

(21) Appl. No.: 12/940,508

(22) Filed: Nov. 5, 2010

Related U.S. Application Data
(60) Provisional application No. 61/259,126, filed on Nov. 7, 2009.
(60) Provisional application No. 61/259,127, filed on Nov. 7, 2009.
(60) Provisional application No. 61/259,128, filed on Nov. 7, 2009.

(51) Int. Cl. G06Q 10/00; G06Q 90/00

(52) U.S. Cl. 705/7.14; 705/7.42

(57) ABSTRACT

A method for managing a workforce is provided. The method includes identifying customer interactions corresponding to an initial work volume handled by a workforce, and identifying comments within the customer interactions related to at least one performance goal used to generate the initial work schedule. The method also includes generating feedback information based on the comments to be used when generating a subsequent schedule.

### RELATED APPLICATIONS

This application hereby claims the benefit of and priority to U.S. Provisional Patent Application No. 61/259,126, titled “WORKFORCE MANAGEMENT SYSTEM WITH SPEECH ANALYTICS”, filed on Nov. 7, 2009, and which is hereby incorporated by reference in its entirety.

This application hereby claims the benefit of and priority to U.S. Provisional Patent Application No. 61/259,127, titled “WORKFORCE MANAGEMENT SYSTEM WITH SPEECH ANALYTICS”, filed on Nov. 7, 2009, and which is hereby incorporated by reference in its entirety.

This application hereby claims the benefit of and priority to U.S. Provisional Patent Application No. 61/259,128, titled “WORKFORCE MANAGEMENT SYSTEM WITH SPEECH ANALYTICS”, filed on Nov. 7, 2009, and which is hereby incorporated by reference in its entirety.

### TECHNICAL BACKGROUND

Many companies manage their workforce by determining work schedules based on expected work volumes, expected staffing levels, and performance goals. These work schedules assign tasks to staff during various time periods in an attempt to enable the staff to process all incoming work in a manner that meets the performance goals. For example, a performance goal may include correcting customer problems within 4 days. This may be a reasonable performance goal given the type of work and current staffing levels. However, customers may have a different view. It is possible for a company to meet all of their work volume and performance goals and still have a large number of customers unhappy with their performance. The company may be unaware of this customer discontent and believe that since they are meeting their performance goals, their work process must be running well, when in fact, they are not meeting their customers' needs or expectations.

### OVERVIEW

A method for managing a workforce is provided. The method includes identifying customer interactions corresponding to an initial work volume handled by a workforce, and identifying comments within the customer interactions related to at least one performance goal used to generate the initial work schedule. The method also includes generating feedback information based on the comments to be used when generating a subsequent schedule.

In another embodiment, a method for managing a workforce is provided. The method includes generating an initial work schedule to handle an initial work volume by a workforce based at least in part on a performance goal, and identifying customer interactions corresponding to the initial work volume handled by the workforce. The method also includes identifying comments within the customer interactions related to the performance goal used to generate the initial work schedule, and generating feedback information based on the comments to be used when generating a subsequent schedule. The method further includes generating the subsequent work schedule to handle a subsequent work volume by the workforce based on the feedback information.

In a further embodiment, a non-transitory computer-readable medium having instructions stored thereon for operating a computer system is provided. The instructions, when executed by the computer system, direct the computer system to identify customer interactions corresponding to an initial work volume handled by a workforce, and to identify comments within the customer interactions related to at least one performance goal used to generate the initial work schedule. The instructions also direct the computer system to generate feedback information based on the comments to be used when generating a subsequent schedule.

### BRIEF DESCRIPTION OF THE DRAWINGS

FIG. 1 is a block diagram illustrating an example workforce management system.

FIG. 2 is a block diagram illustrating an example workforce management system.

FIG. 3 is a block diagram illustrating an example workforce management system.

FIG. 4 is a block diagram illustrating a speech analytics system.

FIG. 5 is a flow chart illustrating a method of managing a workforce.

FIGS. 6(a) and 6(b) are charts illustrating relationships between staffing levels and performance goals, and between staffing levels and work volume.

FIG. 7 is a block diagram illustrating a computer system.

FIG. 8 is a block diagram illustrating an example implied workflow.

### DETAILED DESCRIPTION

The following description and associated drawings teach the best mode of the invention. For the purpose of teaching inventive principles, some conventional aspects of the best mode may be simplified or omitted. The following claims specify the scope of the invention. Some aspects of the best mode may not fall within the scope of the invention as specified by the claims. Thus, those skilled in the art will appreciate variations from the best mode that fall within the scope of the invention. Those skilled in the art will appreciate that the features described below can be combined in various ways to form multiple variations of the invention. As a result, the invention is not limited to the specific examples described below, but only by claims and their equivalents.

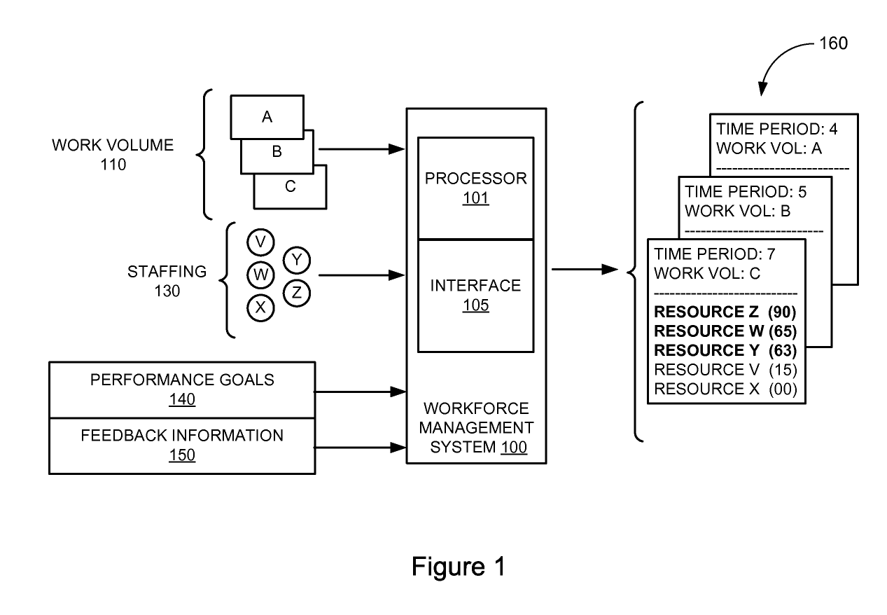

FIG. 1 is a block diagram illustrating an example workforce management system. In this example embodiment, workforce management system 100 (including processor 101 and interface 105) is used to generate work schedules 160. Workforce management system 100 receives inputs work volume 110, staffing 130, performance goals 140, and optionally feedback information 150.

As an example, work volume 110 includes three workflows A, B, and C. Staffing 130 includes resources V, W, X, Y, and Z which may represent employees or staff. Performance goals 140 are used by workforce management system 100 to generate work schedules 160 based on work volume 110 and staffing 130 configured to meet these performance goals 140. Performance goals 140 may include maximum response times, minimum performance levels, or the like.

For example, performance goals 140 may state that a customer complaint must be addressed and corrected within four days. Workforce management system 100 uses this four day goal in assigning resources during various time periods in an attempt to meet this goal. However, simply meeting a performance goal does not ensure customer satisfaction. In some cases, performance goals may be set too leniently and customers may not be satisfied with a response time that meets the performance goal.

In these examples, customers may be both external customers of a company and internal customers of a company. For example, an IT section in a large corporation will have a large number of internal customers who come to them with problems. In the examples described herein, customers may be thought of as any person who uses a product or service provided by staffing 130 or other employees.

Customer dissatisfaction may be expressed in a wide variety of ways. In one example, a call center may receive calls from customers about a particular problem. Agents answering calls from these customers may inform the customer that their problem will be corrected within four days, and the customer may respond with an indication that this performance is unsatisfactory. For example, a customer may exclaim “That's too long.” or “Why are you so slow?” or other similar responses.

In other embodiments, customer interactions may take a variety of forms such as email, instant messages, phone calls, internet chat sessions, internet message board postings, and the like. All of these interactions may be processed to determine customer comments related to the performance goal that was used to generate the initial work schedule.

In an embodiment, a speech analytics system monitoring these customer interactions is configured to detect indications of customer dissatisfaction. The speech analytics system first identifies customer interactions corresponding to a work volume handled by a workforce in accordance with an initial work schedule. A work force handles work volumes by performing tasks related to the various work flows within the work volume. The term “handle” may be thought of as broadly covering the performance of any tasks related to the work volume. The speech analytics system then identifies comments within these customer interactions related to the performance goal that was used to generate the initial work schedule.

In response to these comments, the speech analytics system generates feedback information 150 for the workforce management system 100 to be used when generating a subsequent work schedule 160. The subsequent work schedule 160 is configured to address these customer concerns. The feedback information 150 may take any of a variety of configurations. For example, the feedback information 150 may recommend modifications to the performance goals 140 to meet customer expectations. The feedback information 150 may alternatively recommend modifications to work volume 110 to indicate that additional work will be coming in the near future.

In many cases, feedback information 150 will indicate that performance goals 140 need to be increased in order to meet customer expectations. However, it is also possible that the current performance goals 140 are exceeding customer expectations, and that the performance goals 140 may be decreased while continuing to meet customer expectations. In such a case, subsequent work schedules 160 may be created with lower staffing levels in a cost saving measure.

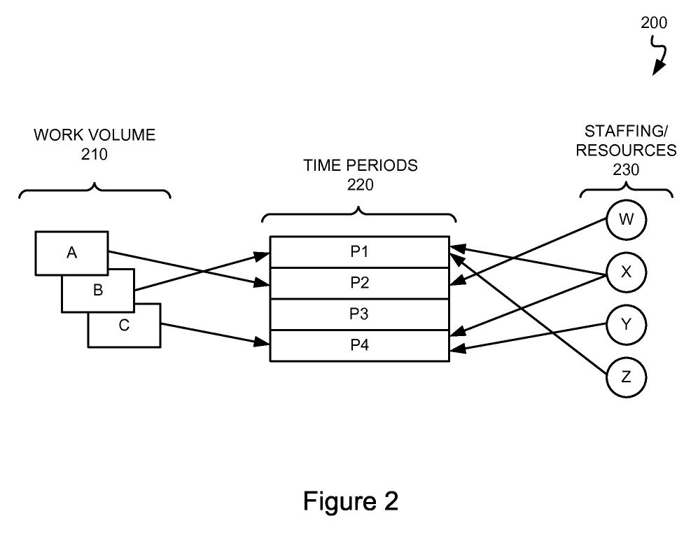

FIG. 2 is a block diagram illustrating an example workforce management system. In this example embodiment, workforce management system 200 receives work volume data 210 related to three different tasks A, B, and C, along with staffing resources 230 W, X, Y, and Z. Here four time periods 220 P1, P2, P3, and P4 need to be staffed. Workforce management system 200 assigns staffing resources 230 to each of the time periods as indicated by work volume 210 and any performance goals.

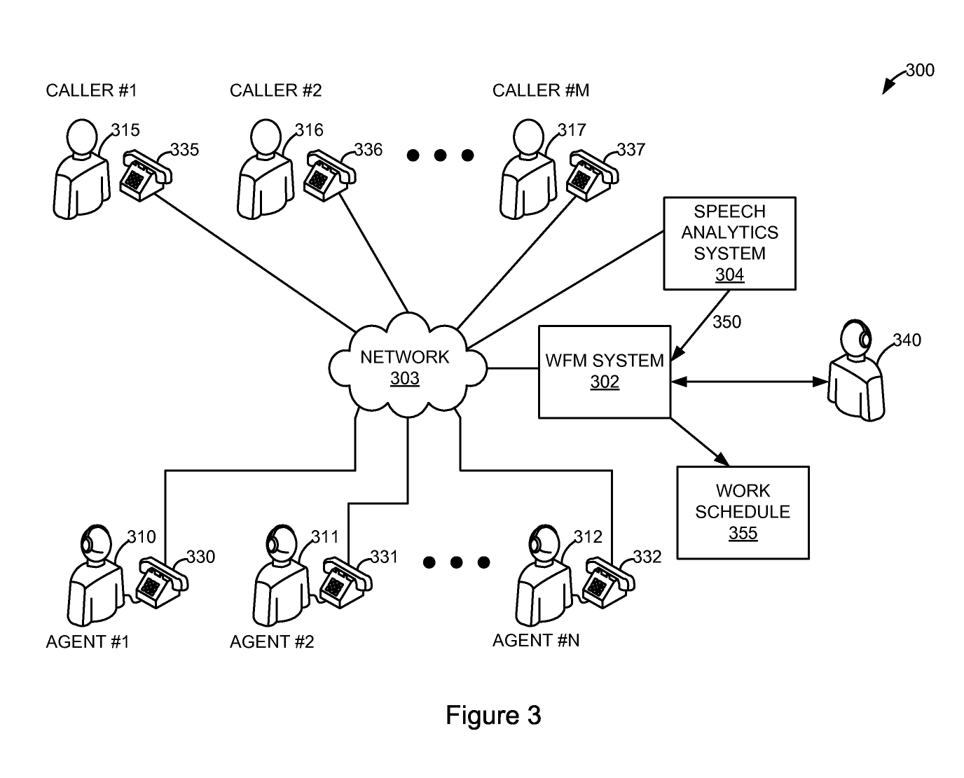

FIG. 3 is a block diagram illustrating an example workforce management system. Workforce management (a.k.a. workforce optimization) system 300 includes workforce management (WFM) system 302, network 303, speech analytics system 304, agents 310-312, agent telephones 330-332, callers 315-317, caller telephones 335-337, and quality monitoring evaluation 340.

Callers 315-317 use caller telephones 335-337, respectively, to place calls via network 303. Network 303 assigns incoming calls and operatively links caller telephones 335-337 and agent telephones 330-332. Agents 310-312 use agent telephones 330-332, respectively, to service these incoming calls. Thus, agents 310-312 may use voice communication exchanged via caller telephones 335-337 through network 303 and agent telephones 330-332 to assist callers 315-317.

Caller telephones 335-337 and agent telephones 330-332 may be any device, system, combination of devices, or other such communication platform capable of communicating audio via network 303. Any of caller telephones 335-337 or agent telephones 330-332 may be, for example, an expanded function telephone, a mobile phone, a wireless phone, a wireless modem, a personal digital assistant (PDA), a computer system with a sound input, output, and an internet connection, a computer with a public switched telephone network (PSTN) connection, a computer with a network card, an access terminal, a voice over internet protocol (VoIP) phone, a voice over packet (VOP) phone, or a soft phone, as well as other types of devices or systems that can exchange audio via network 303.

Network 303 may be any network or collection of networks that couple, link, or otherwise operatively link caller telephones 335-337 with agent telephones 330-332. In addition, other secondary data networks could be used. In an example, network 303 may include a backhaul network, a local network, a long distance network, a packet network, the internet, or any combination thereof, as well as other types of networks.

Network 303 may include a system or collection of systems or software that link or otherwise assign incoming calls from caller telephones 335-337 to agent telephones 330-332. Network 303 may include, but is not limited to, CTI technologies and applications such as intelligent private branch exchanges (PBXs), computerized ACD systems, call servers, fax servers, interactive voice response (IVR) systems, voice mail, messaging systems, and so on.

WFM system 302 may perform many functions. One such function is providing a call center supervisor or manager with information about agents 310-312. This information may be historical or real-time. Another function of WFM system 302 is supplying the supervisor with information on how well each agent 310-312 complies with customer center policies. This information may be based on one or more of quality monitoring evaluation 340. Yet another function is calculating staffing levels and creating agent schedules based on historical patterns of incoming calls. The functionality of WFM system 302 is typically divided among several applications. Some of these applications have a user interface component. WFM system 302 comprises a suite of applications.

In FIG. 3, taken together, agents 310-312, agent telephones 330-332, WFM system 302, quality monitoring evaluation 340, and speech analytics system 304 comprise a call center. A call center may include, but is not limited to, outsourced customer centers, outsourced customer relationship management, customer relationship management, voice of the customer, customer interaction, customer center, multi-media customer center, remote office, distributed enterprise, work-at-home agents, remote agents, branch office, back office, performance optimization, workforce optimization, hosted customer centers, and speech analytics. It should be understood, however, that workforce management system 300 may be applied to other industries. For example, workforce management system 300 may be used to optimize banking tasks such as front office or branch tasks as well as back office work such as processing checks. In this case, agents 310-312 would correspond to employees or staff, and callers 315-317 would correspond to customers.

In an embodiment, WFM system 302 may include one or more of a performance manager, an evaluation manager, and a development manager. The evaluation manager allows various types of agent 310-312 review processes to be managed (i.e. 360 degree reviews). The evaluation manager may receive or generate information about agents 310-312 based on a variety of data sources including data from quality monitoring evaluation 340 and speech analytics system 304.

The performance manager receives data from the evaluation manager. The performance manager presents the performance data to the call center manager through various scorecard views. The development manager tracks agent learning/development and detects the need for training The development manager may generate or receive information about agents 310-312 based on a variety of data sources, including quality monitoring evaluation 340.

Quality monitoring evaluation 340 may use speech analytics (i.e., the analysis of recorded or real-time speech) or a human listener to perform a variety of functions. The results of speech analytics may be received from speech analytics system 104. These functions may include automated call evaluation, call scoring, quality monitoring, quality assessment and compliance/adherence. For example, quality monitoring evaluation 340 may compare a recorded interaction between one of agent 310-312 and one of caller 315-317 to a script (e.g., a script that the agent 310-312 was to use during the interaction). In other words, quality monitoring evaluation 340 may measure how well agents 310-312 adhere to scripts. This allows the agents 310-312 to be identified that are “good” sales people and which ones may need additional training. As such, quality monitoring evaluation 340 may find agents 310-312 that do not adhere to scripts.

In another example, quality monitoring evaluation 340 may determine compliance with various policies. This may be important, for example, in a highly regulated business where agents 310-312 must abide by many rules. The collections industry is an example of such a business.

Also included in this disclosure are embodiments of WFM system 302 included in U.S. patent application Ser. No. 11/359,356, filed on Feb. 22, 2006, titled “Systems and Methods for Workforce Optimization,” and U.S. patent application Ser. No. 11/540,185, filed on Sep. 29, 2006, titled “Systems and Methods for Facilitating Contact Center Coaching,” both of which are hereby incorporated herein by reference in their entireties for all purposes.

At least one embodiment of WFM system 302 may include: (1) quality monitoring/call Recording—voice of the customer; the complete customer experience across multimedia touch points; (2) workforce management—strategic forecasting and scheduling that drives efficiency and adherence, aids in planning, and helps facilitate optimum staffing and service levels; (3) performance management—key performance indicators (Kips) and scorecards that analyze and help identify synergies, opportunities and improvement areas; (4) e-learning—training, new information and protocol disseminated to staff, leveraging best practice customer interactions and delivering learning to support development; (5) analytics—deliver insights from customer interaction to drive business performance; and/or (6) coaching—feedback to promote efficient performance. Quality monitoring evaluation 340 may provide information used by one or more of these parts of WFM system 302. In addition, WFM system 302 may generate information used internally by one or more parts of WFM system 302.

Workforce management system 302 may be used to collect and analyze data about the volume of work that will result when a task is completed or a work event occurs. The collected data is used to forecast what resources will be necessary to complete other tasks that will occur as a result of the task or work event. This way, resources can be moved from areas that have too many resources to areas that have too few resources.

As described with respect to FIG. 1, speech analytics system 304 first identifies customer interactions corresponding to a work volume handled by a workforce (such as agents 310-312) in accordance with an initial work schedule. Speech analytics system 304 then identifies comments within these customer interactions related to the performance goal that was used to generate the initial work schedule.

In response to these comments, the speech analytics system generates feedback information 350 for the workforce management system 302 to be used when generating a subsequent work schedule 355. The subsequent work schedule 355 is configured to address these customer concerns. The feedback information 350 may take any of a variety of configurations. For example, the feedback information 350 may recommend modifications to the performance goals to meet customer expectations. The feedback information 350 may alternatively recommend modifications to work volume to indicate that additional work will be coming in the near future.

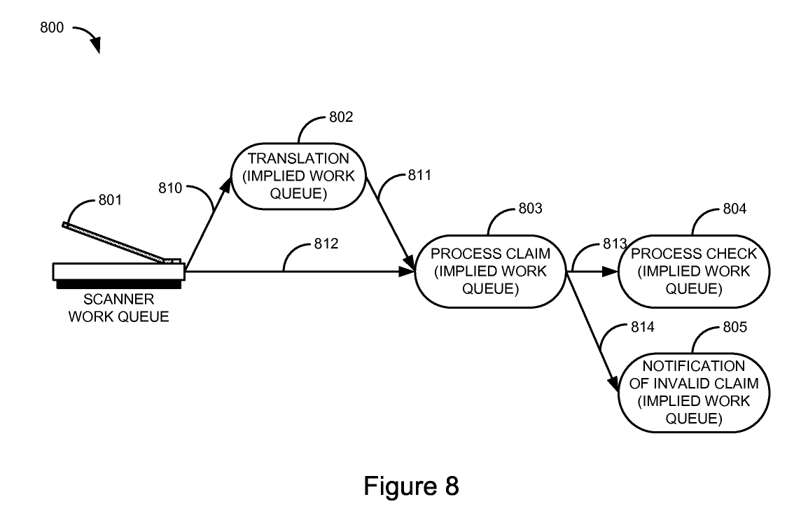

Workforce management system 302 may model a work process into work queues. A work process comprises one or more work queues that track the steps of the work process. For example, in banking, a method of processing checks would be a work process. The processes of opening envelopes that contain checks, verifying checks, and storing checks are examples of work queues. In this example, the work process of processing checks is modeled into the work queues of opening checks, verifying checks, and storing checks. This example work process is illustrated in FIG. 8 and described below in detail. In another example, in a call center, a certain type of call (e.g., balance inquiry, loan application, etc.) may be a work process.

When work arrives or leaves a work queue, it is a work event. In the above banking example, when a check arrives to be opened and this is entered into the system, it is an arrival work event. An arrival work event would increase the amount of work to be done in the opening envelopes work queue. Adding an arrival is a means of entering volume into the system. Typically adding an arrival value for a queue increases the inventory of that queue by that value. In the above call center example, a call may be an arrival work event.

Two other types of work events are checkin and checkout work events. The checkout work event identifies a quantity of inventory as being moved to another queue (such as a quantity of work being worked on by a particular worker). Checking work out from a queue decreases the inventory level of that queue by that value. It also increases the Work In Progress (WIP) of the receiving queue by that value.

When work tied to a queue that has been checked out is completed, it can be checked back in with a checkin event. The checkin event process reduces the amount from the WIP tally for that queue by the value of the Checkin event. For example, when a caller to a call center hangs up, the work tied to the call queue is completed.

The modeled work queues are organized into work queues and implied work queues. A work queue is a step in the workflow process where the quantity of work waiting to be done (e.g., inventory), or in the process of being done (e.g., WIP), at that step is measured or externally entered into the system. An implied work queue is a step in the workflow process where the quantity of work at that step is not measured or externally entered into the system. Instead, the amount of inventory and WIP associated with an implied work queue is determined by implied work events.

A work event (or actual work event) is a work event that is measured or externally entered into the system. For example, a worker or manager entering in an arrival, checkout, or checkin event into the system. In another example, automated means may enter an event (e.g., a call) into the system. Work events that are externally entered into the system as may start an implied workflow of implied work events. These implied work events may be chained so that one implied work event triggers other implied work events.

An implied work event is not an actual event that is entered into the system (e.g., as in a worker entering an arrival, checkin or checkout event) by a user or automated equipment. Instead, an implied work event is an event that is implied to happen based on the knowledge of the workflow and the entry into the system of an actual work event.

For example, it may be known that checks are verified after they are received. Accordingly, completing the work of verifying checks may be implied from the event of completing the opening a number of envelopes that contain checks. Likewise, storing a certain number of checks may be implied from completing the verification of a quantity of checks. Modeling the work process into work queues, implied work queues, work events and implied work events may be accomplished by a user entering the information into a computer.

Workforce management system 302 may create a link between a work queue and an implied work queue. A link may be represented by a data structure in a computer. A link is an association of data about what will likely occur when an actual work event happens or a prior implied work event happens. The information that an actual work event happened may be entered into the workforce management system by a user, or may be entered by automated means.

To illustrate links, consider an example where there is a work queue of opening envelopes and an implied work queue of verifying checks. A link may be created in the system that specifies that for each envelope arriving at the open envelopes queue, a check will arrive at the verify checks queue one day later. Accordingly, for every arrival work event that affects the opening envelopes queue, the system will generate an implied work event to update the inventory and/or WIP in the verify checks queue. Therefore, the workforce management system processes the implied events of new checks arriving into the verification queue as if it had been entered by a user (even though it had not.)

Implied queues may be linked to other implied queues thereby triggering a chain of implied events. For example, the implied event of a new check being entered into the verification queue may trigger a link to an error resolution queue. This link may indicate that only some percentage (for example 1%) of the checks entered into the verification queue results in a check going to the error resolution queue. The links from open envelope queue to the verification queue to the error resolution queue is a chain of implied events. In the above example, an actual event of one hundred envelopes arriving at the open envelopes queue would trigger an implied event of one hundred checks arriving in the verification queue which, in turn, would trigger an implied event of one check arriving in the error resolution queue. The workforce management system uses the entries of work into these queues to perform its functions.

The data associated with a link may indicate a variety of data such as time, percentages, work volume, units of work, work in progress, and the like. The data associated with the link may be generated based on historical data that is created and stored from previous iterations of the process. The data associated with the link may also be created by a user. The data associated with a link may also include an “event state.” An event state is an attribute associated with a link that determines when work moves from an actual or implied work queue to an implied queue. The event state reflects when work arrives at a work queue, when work is in progress, and when work is completed.

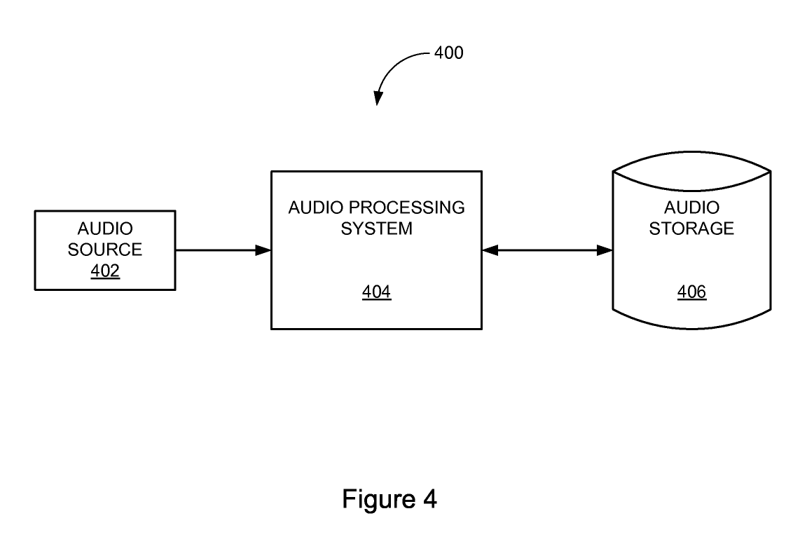

FIG. 4 illustrates a speech analytics system. Speech analytics system 400 is suitable for use as speech analytics system 404 shown in FIG. 3. Speech analytics system 400 includes audio source 402, audio processing system 404, and audio storage system 406. Audio source 402 is coupled to audio processing system 404, and audio processing system 404 is coupled to audio storage system 406. The connections between the elements of speech analytics system 400 may use various communication media, such as air, metal, optical fiber, or some other signal propagation path—including combinations thereof. They may be direct links, or they might include various intermediate components, systems, and networks. As shown in FIG. 3, audio sources may be coupled to a speech analytics system via a network. For example, audio source 402 may be or comprise caller telephones 335-337 and agent telephones 330-332 coupled to speech analytics system 304 (or 400) via network 303.

Speech analytics system 400 may use automatic methods of analyzing speech to extract useful information about the speech content or the speakers. Speech analytics system 400 may include automatic speech recognition functions. These automatic speech recognition functions may determine the identities of spoken words or phrases. Speech analytics system 400 may also include analysis to determine one or more of the following: a topic being discussed; an identity of a speaker; the gender of a speaker; the emotional character of the speech; and, the amount and locations of speech versus non-speech (e.g. background noise or silence).

In addition to storing audio, the speech analytics system 400 should also store searchable metadata that describes the speech or activity that was detected through audio analysis. The speech analytics system 400 should enable users (or workforce management system 302) to leverage metadata to support rapid searching for activity that matches user-defined criteria without having to wait while the system decodes and analyzes audio. In an embodiment, audio is analyzed one time when the audio is originally captured (before compression) and the results of that analysis should be saved as searchable metadata. Thus, speech analytics system 400 may transform audio input signals into data suitable for use by workforce management system 302. In addition, this data may be displayed. The captured audio may be played back on a speaker (not shown).

In the embodiment of FIG. 1, speech analytics system 400 first identifies customer interactions corresponding to a work volume handled by a workforce (such as agents 310-312) in accordance with an initial work schedule. Speech analytics system 304 then identifies comments within these customer interactions related to the performance goal that was used to generate the initial work schedule.

In response to these comments, speech analytics system 400 generates feedback information for the workforce management system to be used when generating a subsequent work schedule. The subsequent work schedule is configured to address these customer concerns. The feedback information may take any of a variety of configurations. For example, the feedback information may recommend modifications to the performance goals to meet customer expectations. The feedback information may alternatively recommend modifications to work volume to indicate that additional work will be coming in the near future.

In an embodiment, speech analytics system 304 may detect calls from callers 315-317 that indicate a problem. Speech analytics system 304 may pass this information to WFM system 302. WFM system 302 may then use this data, along with its own knowledge, to determine the cause of the problem. WFM system 302 may use, for example, its knowledge of a work process and staffing information to correlate the cause of the problem. For example, WFM system 302 may detect that the call center was short staffed at the time of the problem calls. In another example, WFM system 302 may detect that a particular agent(s) 310-312 did not have the proper training. In another example, WFM system 302 may determine that the call center had a large backlog of calls when the problem calls were detected.

In an embodiment, speech analytics system 304 may detect the topic of calls from callers 315-317. This data may be passed to WFM system 302 so that it is associated with a link. This data may be used as the historical data, described previously, that is created and stored from previous iterations of the process. Thus, the detected topic may be linked and chained, as described above, to help model or forecast call volumes associated with a call topic. For example, large volumes of account closure calls at certain times can be detected by WFM system 302 using the call topic data received from speech analytics system 304. This allows WFM system 302 to recommend appropriate staffing, at an appropriate time, for a high volume of account closure transactions.

In an embodiment, speech analytics system 304 may detect trend (e.g., emotion vs. time) information. For example, speech analytics system 304 may detect a customer's mood during a call. This trend information may be passed to WFM system 302 for analysis. For example, WFM system 302 may specify a 4 day time period for the completion of a certain task(s). Speech analytics system 304 may detect disappointment on the part of callers 315-317 when they are told their task will take 4 days to complete. These detections may be registered with WFM system 302. As a result, WFM system 302 may reduce the completion of these task(s) to 3 days. In addition, WFM system 302 may recommend appropriate staffing to accomplish the new goal of a 3-day completion.

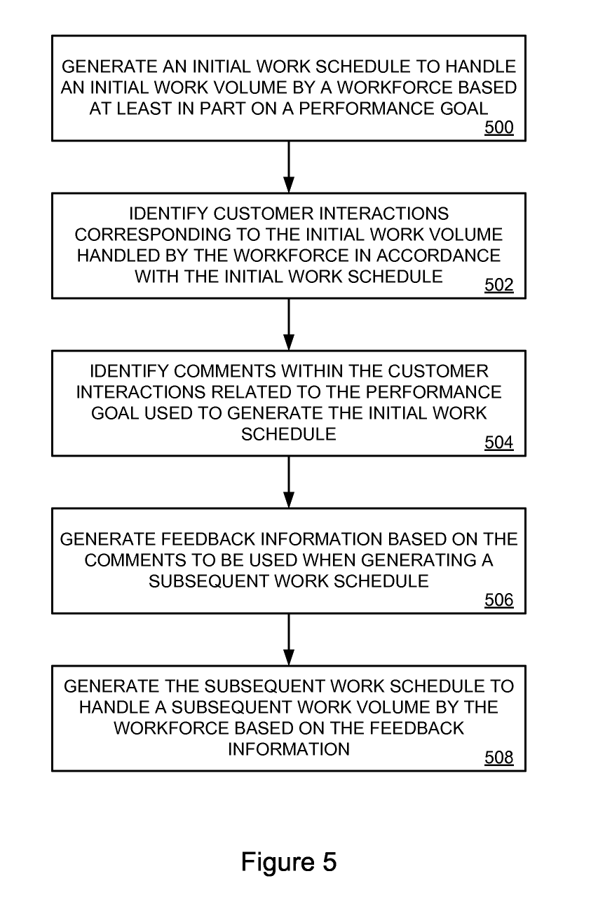

FIG. 5 is a flow chart illustrating a method of managing a workforce. In this example embodiment, workforce management system 100 generates an initial work schedule 160 to handle an initial work volume by a workforce 130 based at least in part on a performance goal 140, (operation 500). A speech analytics system 400 identifies customer interactions corresponding to the initial work volume 110 handled by the workforce 130 in accordance with the initial work schedule 160, (operation 502).

The speech analytics system 400 then identifies comments within the customer interactions related to the performance goal 140 used to generate the initial work schedule 160, (operation 504). The speech analytics system 400 generates feedback information 150 based on the comments to be used by the workforce management system 100 when generating a subsequent work schedule 160, (operation 506). The workforce management system 100 generates the subsequent work schedule 160 to handle a subsequent work volume 110 by the workforce 130 based on the feedback information 150, (operation 508).

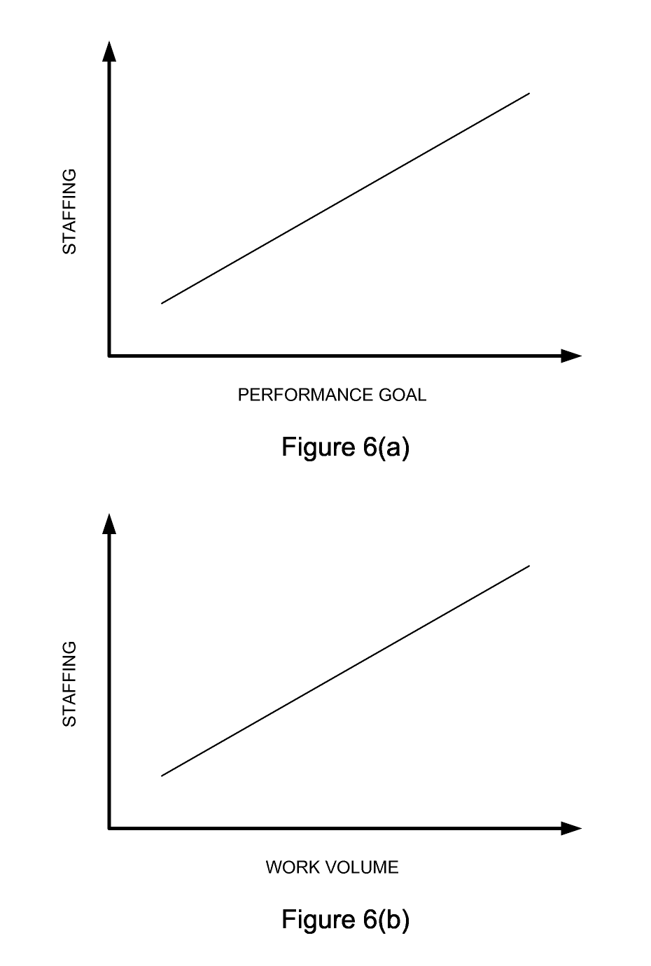

FIGS. 6(a) and 6(b) are charts illustrating relationships between staffing levels and performance goals, and between staffing levels and work volume. FIG. 6(a) illustrates the relationship between required staffing levels and performance goals. As performance goals are increased, increasing staffing levels are required to meet these performance goals. In an example, an increased performance goal may include a decreased response time to customer problems. Increasing staffing levels typically are required to respond to decreasing response times.

FIG. 6(b) illustrates the relationship between required staffing levels and work volume. As work volume increases, increased staffing levels are required to meet this work volume. In one example, increased work volume may include additional tasks to be performed by additional staff members. Increasing staffing levels typically are required to respond to increasing work volumes.

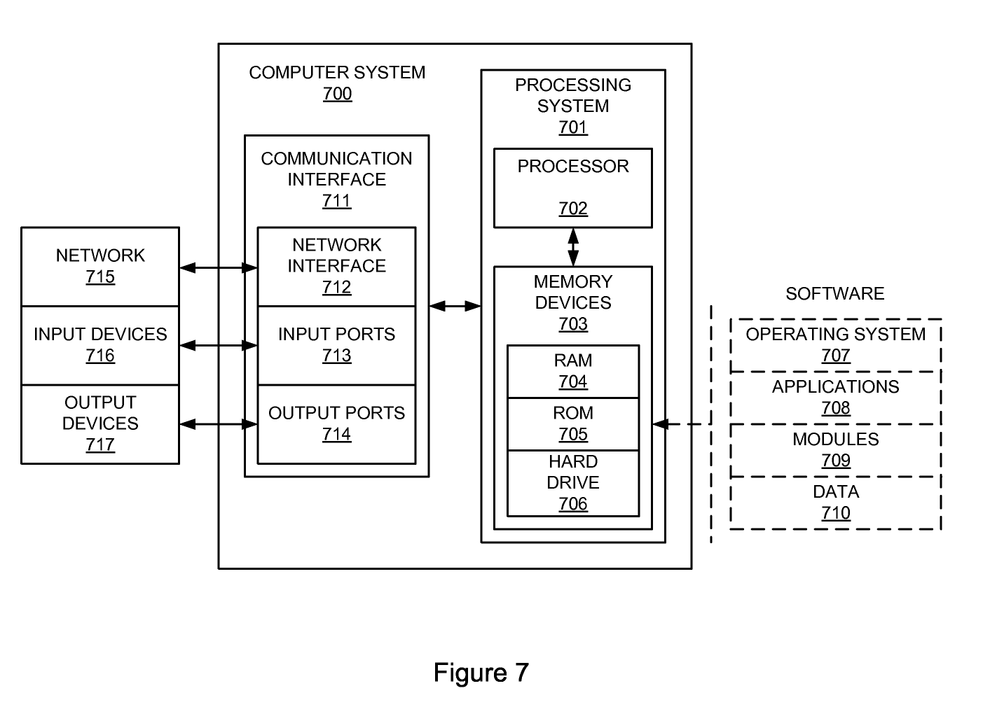

Many embodiments include a computer system such as speech analytics system 304 and WFM system 302 from FIG. 3, and audio processing system 404 from FIG. 4. Any of these systems may be implemented using a computer system such as that shown in FIG. 7. Computer system 700 includes communication interface 711, and processing system 701. Processing system 701 is linked to communication interface 711 through a bus. Processing system 701 includes 702 and memory devices 703 that store operating software.

Communication interface 711 includes network interface 712, input ports 713, and output ports 714. Communication interface 711 includes components that communicate over communication links, such as network cards, ports, RF transceivers, processing circuitry and software, or some other communication devices. Communication interface 711 may be configured to communicate over metallic, wireless, or optical links. Communication interface 711 may be configured to use TDM, IP, Ethernet, optical networking, wireless protocols, communication signaling, or some other communication format—including combinations thereof.

Network interface 712 is configured to connect to external devices over network 715. In some examples these network devices may include audio sources and audio storage systems as illustrated in FIGS. 3 and 4. Input ports 713 are configured to connect to input devices 716 such as a keyboard, mouse, or other user input devices. Output ports 714 are configured to connect to output devices 717 such as a display, a printer, or other output devices.

Processor 702 includes microprocessor and other circuitry that retrieves and executes operating software from memory devices 703. Memory devices 703 include random access memory (RAM) 704, read only memory (ROM) 705, a hard drive 706, and any other memory apparatus. Operating software includes computer programs, firmware, or some other form of machine-readable processing instructions. In this example, operating software includes operating system 707, applications 708, modules 709, and data 710. Operating software may include other software or data as required by any specific embodiment. When executed by processor 702, operating software directs processing system 701 to operate computer processing system 700 as described herein.

FIG. 8 is a block diagram illustrating an example implied workflow. To illustrate, consider an implied workflow 800 that is an insurance claim process. The implied workflow 800 comprises: a scanner work event 801; a translation implied work queue 802; a process claim implied work queue 803; a process check implied work queue 804; and, a notification of invalid claim implied work queue 805.

Link 810 is between scanner work queue 801 and translation implied work queue 802. Link 811 is between translation implied work queue 802 and process claim implied work queue 803. Link 812 is between scanner work queue 801 and process claim implied work queue 803. Link 813 is between process claim implied work queue 803 and process check implied work queue 804. Link 814 is between process claim implied work queue 803 and notification of invalid claim implied work queue 805. The linking of work queues forms a chain of work queues.

The example insurance claim process is modeled into scanner work queue 801, translation implied work queue 802, process claim implied work queue 803, process check implied work queue 804, and notification of invalid claim implied work queue 805. Implied work queues 802-805 are modeled to match implied workflow 800. Implied work queues 802-805 may be created by a user. Implied work queues 802-805 may be generated by a computer based on historical or other data.

Link 810 is created between scanner work queue 801 and translation implied work queue 802. Link 812 is created between scanner work queue 801 and process claim implied work queue 803. Link 811 is created between translation implied work queue 802 and process claim implied work queue 803. Link 813 is created between process claim implied work queue 803 and process check implied work queue 804. Link 814 is created between process claim implied work queue 803 and notification of invalid claim implied work queue 805. Links 810-814 may be created by a user. Links 810-814 may be generated by a computer based on historical or other data. The historical data used to create a link may be based on the time required to accomplish the steps of an implied queue, volume of work, duration, units of work, work in progress, and the like.

Consider an example where link 810 indicates that 20% of the insurance claim forms scanned will need to be translated and link 812 indicates that 80% of the insurance claim forms will not need translation and are ready for processing. Links 811 and 812 may also have an associated time value. For example, link 811 may have a time value that indicates that two days elapse between an arrival at translation implied work queue 802 and an arrival at process claim implied work event 803.

In this example, further consider a case where link 813 indicates that 75% of claims are valid and are ready for processing checks and link 814 indicates that 25% of claims are invalid and require notification of an invalid claim. Links 813 and 814 may also have an associated time value. For example, link 813 may have a time value indicating that twenty minutes elapse between arrival at the process claim queue and arrival at process check queue. Link 814 may have a time value indicating that thirty minutes are required between arrival at process claim queue and arrival at notification of invalid claim queue.

The “time delays” between work flowing from one work queue to the next is achieved through the notion of a custom pattern (e.g., distribution of weights over time) which is applied to the volume of work flowing from work queue to work queue (actual or implied) associated with the link. The pattern has the effect of shifting volumes of work associated with different time periods to simulate how work would optimally have been complete by in downstream work queues in the work flow. The workforce management system forecasts staffing levels at the various work queues based on the time and volume distribution at each work queue.

When a work event is entered that affects scanner work queue 801, the system generates implied work events based on the modeled work process and the one or more links created between scanner work queue 801 and the implied work queues 802 and 803. For example, when a work event that changes the inventory at scanner work queue 801 is received, a work event that changes the inventory or WIP at translation implied work queue 802 is generated based on link 810. Also, a work event that changes the inventory or WIP at process claim implied work queue 803 is generated based on link 812.

When a work event that affects scanner work queue 801 is received, information is updated about scanner work queue 801. For example, the inventory of documents to be scanned, the document being scanned (WIP). Other information such as the time each document was scanned, who scanned the document, the number of pages of each document, and the like may also be recorded.

Based upon information about the actual work event, and the links between work events (both actual and implied) information is updated about implied work events. For example, as a result of the scanner entering a work event that one hundred letters have been scanned, the system may update translation implied work queue to indicate that twenty forms are waiting to be translated. Likewise, when implied work queue of process claim 803 updates to show that eighty forms are ready for the process check step, the system may update the process check queue to indicate that eighty more checks are waiting to be processed. In this example, information indicating that in two days another twenty forms from the translation implied work queue will be added into the process claim implied work queue may also be updated.

In this way, and using the above example, a workforce management system may allow proper resources to be allocated to the translation department. For example, if twenty claims are ready for translation and a person can translate five claims in two days, it will be necessary to have four translators to process the twenty claims in two days. If there are currently three translators working on translation, a fourth translator can be moved to the translation department to handle the project work load. Likewise, the proper resources can be allocated to claim processing so that the eighty claims can be processed on schedule. As the process flows through the implied events, resources can be allocated based on the projected resources required for the next implied event in the flow. For example, as claims are processed, the proper resources can be allocated for check processing and invalid claim notification.

The above description and associated figures teach the best mode of the invention. The following claims specify the scope of the invention. Note that some aspects of the best mode may not fall within the scope of the invention as specified by the claims. Those skilled in the art will appreciate that the features described above can be combined in various ways to form multiple variations of the invention. As a result, the invention is not limited to the specific embodiments described above, but only by the following claims and their equivalents.

1. A method for managing a workforce comprising:
identifying customer interactions corresponding to an initial work volume handled by a workforce in accordance with an initial work schedule;
identifying comments within the customer interactions related to at least one performance goal used to generate the initial work schedule; and
generating feedback information based on the comments to be used when generating a subsequent schedule.

2. The method of claim 1, wherein the customer interaction comprises one or more of emails, instant messages, phone calls, internet chat sessions, and internet message board postings.

3. The method of claim 1, wherein the customer interactions corresponding to the initial work volume are identified by a speech analytics system.

4. The method of claim 1, wherein the comments within the customer interactions related to the at least one performance goal are identified by a speech analytics system.

5. The method of claim 1, wherein the feedback information includes a recommendation to modify the performance goal.

6. The method of claim 5, wherein the recommendation to modify the performance goal includes increasing the performance goal.

7. The method of claim 5, wherein the recommendation to modify the performance goal includes decreasing the performance goal.

8. A method for managing a workforce comprising:
generating an initial work schedule to handle an initial work volume by a workforce based at least in part on a performance goal;
identifying customer interactions corresponding to the initial work volume handled by the workforce;
identifying comments within the customer interactions related to the performance goal used to generate the initial work schedule;
generating feedback information based on the comments to be used when generating a subsequent schedule; and
generating the subsequent work schedule to handle a subsequent work volume by the workforce based on the feedback information.

9. The method of claim 8, wherein the customer interaction comprises one or more of emails, instant messages, phone calls, internet chat sessions, and internet message board postings.

10. The method of claim 8, wherein the customer interactions corresponding to the initial work volume are identified by a speech analytics system.

11. The method of claim 8, wherein the comments within the customer interactions related to the at least one performance goal are identified by a speech analytics system.

12. The method of claim 8, wherein the feedback information includes a recommendation to modify the performance goal.

13. The method of claim 12, wherein the recommendation to modify the performance goal includes increasing the performance goal.

14. The method of claim 12, wherein the recommendation to modify the performance goal includes decreasing the performance goal.

15. A non-transitory computer-readable medium having instructions stored thereon for operating a computer system, wherein the instructions, when executed by the computer system, direct the computer system to:
identify customer interactions corresponding to an initial work volume handled by a workforce in accordance with an initial work schedule;
identify comments within the customer interactions related to at least one performance goal used to generate the initial work schedule; and
generate feedback information based on the comments to be used when generating a subsequent schedule.

16. The non-transitory computer-readable medium of claim 15, wherein the customer interactions corresponding to the initial work volume are identified by a speech analytics system.

17. The non-transitory computer-readable medium of claim 15, wherein the comments within the customer interactions related to the at least one performance goal are identified by a speech analytics system.

18. The non-transitory computer-readable medium of claim 15, wherein the feedback information includes a recommendation to modify the performance goal.

19. The non-transitory computer-readable medium of claim 18, wherein the recommendation to modify the performance goal includes increasing the performance goal.

20. The non-transitory computer-readable medium of claim 18, wherein the recommendation to modify the performance goal includes decreasing the performance goal.
